(19) United States
(12) Patent Application Publication
(10) Pub. No.: US 2026/0186125 A1
(43) Pub. Date: Jul. 2, 2026

(54) SYSTEM AND METHOD FOR DETECTING AVALANCHES, LANDSLIDES AND ROCKFALL

(71) Applicant: GEOPRAEVENT AG, Zürich (CH)

(72) Inventors: Tobias Schoch, Zürich (CH); Thomas Ehrat, Freienstein (CH)

(21) Appl. No.: 19/131,568

(22) PCT Filed: Nov. 13, 2023
(86) PCT No.: PCT/EP2023/081615

§ 371 Date: May 21, 2025

(30) Foreign Application Priority Data
Nov. 23, 2022 (CH) CH001395/2022

(51) Int. Cl. G01S 13/88; G01S 7/41; G01S 13/32

(52) U.S. Cl. CPC G01S 13/885; G01S 7/415; G01S 13/32

(57) ABSTRACT

A system for determining a path of a movement of mass in a terrain includes a radar device and an evaluation unit which is configured, on the basis of receiving signals, to determine whether a movement of mass activity is present or not at a defined position. This results, in case a movement of mass is present, in movement of mass activities for different points. The evaluation unit determines a path of the movement of mass from a temporal development of the positions of the points for which a movement of mass activity has been ascertained. For determining the path, a cluster of the points can be formed by way of a clustering method.

### BACKGROUND OF THE INVENTION

### Field of the Invention

The invention relates to a system and a method for determining a path of movements of mass in terrain, specifically of snow avalanches or mass movements of earth (landslides, rockfall).

### Description of Related Art

There is a need to determine the courses, in particular the paths and the spatial extension of movements of mass (snow avalanches, landslides, rockfall and the like), in order to better understand such movements of mass, for making prognoses, and also to be able to warn those affected of dangers in good time.

According to the state of the art, the determination of courses of movements of mass is in particular accomplished visually, by way of photographs or possibly film recordings with which the avalanche or rockfall is detected during the fall or thereafter, and is possibly surveyed. A disadvantage of this is that the time of the day and the weather dictate whether such a determination is possible at all. The view during such events is very often unfavourable, for example due to weather conditions and/or due to the time of day, so that the path and the spatial extension of snow avalanches, rockfall or similar events can only be determined hours or even days later. Also, information on the dynamics (speed, temporal sequence of sequential part-events etc.) is often not possible or only possible to a limited extend.

An approach according to which an avalanche is observed with a radar device is discussed in Ash Matthew et al., “Two-dimensional radar imaging of flowing avalanches” Cold Regions Science and Technology 102, p. 41-51 (2014). An avalanche path is manually measured in retrospect on the basis of recorded radar pictures by way of the spatial coordinates of the radar signal maxima being noted in pictures which are take in one-second intervals, and being imaged onto a geographic coordinate system. This manual method is based on the competence of qualified people who interpret the radar pictures, exclude artefacts and evaluate them manually. This would not be suitable for everyday application.

### SUMMARY OF THE INVENTION

It is therefore an object of the present invention to remedy this and to provide a system as well as a method for determining a path of an avalanche which overcome the disadvantages of the state of the art and in particular permit a detection of the path independently of weather conditions and of the time of day.

According to an aspect of the invention, a system for determining a path of a movement of mass in a terrain includes a radar device, i.e. a device with at least one emitting antenna for emitting primary radio waves and at least one receiving antenna for generating receiving signals which are caused by secondary radio waves which are reflected by the terrain due to the primary radio waves. The system further includes an evaluation unit which is configured to determine from the receiving signals whether, at a defined position—represented by a position coordinate value, for example range and azimuth —, a movement of mass activity is present or not. From this, movement of mass activities for different position coordinate values result, given the presence of a movement of mass. The evaluation unit is configured to determine a path of the movement of mass from a temporal development of the position coordinate values (i.e. ultimately of the positions), for which a movement of mass activity has been ascertained.

In contrast to the state of the art therefore, a path is not determined retrospectively on the basis of the situation which is caused by the movement of mass and of models, but an observation of the movement of mass is used whilst it happens, thus in real-time, and the temporal development of this movement of mass is taken into account.

In contrast to the mentioned state of the art according to Ash Matthew et al., the suggested approach is not based on a manual evaluation of the recorded data after the event, but the evaluation unit is capable of determining a path. The fact that the evaluation unit is “configured” to determine the path means that it includes the means, in particular includes that it is configured to do this and that it includes all means for determining the path. In particular, it can mean that the evaluation unit can determine the path in an automatic manner, in particular without any manual activity of a person.

In contrast to the state of the art, the path is also not determined on the basis of recorded picture data, but on the basis of a radar signal which arises during the procedure. Although this has the apparent disadvantage of the terrain having to be permanently monitored by the radar device, since generally one cannot predict, at least not to a precise extent, at what time a movement of mass event will take place, however this apparent disadvantage is not too serious. Indeed, it is already known to monitor a terrain with a radar system, in order to detect possible avalanche falls, rockfall events or the like, in real time and for example to set up road blocks. For this reason, the continuous monitoring of the terrain is given anyway in many cases, and the respective radar device can be used as the radar device of the system according to the invention.

The approach according to the invention has important advantages overriding the mentioned, apparent disadvantage.

The determining of a path by way of a radar signal can be accomplished for example in real time. The determining of the path can consequently be accomplished very rapidly and for example it can even be incorporated into terrain monitoring and into corresponding measures to be taken—i.e. an added effect can be that the determining of the path complements and improves the terrain monitoring. For example, an additional criterion for a differentiation between signals which are activated by way of real movements of mass in the terrain and between those which are activated by other events (for example vehicles moving in the terrain) or by artefacts can be differentiated on the basis of the path. It is only when a determined path—and under certain circumstances the temporal development of the ascertained movement in the terrain—corresponds to a pattern which is realistic for movements of mass, that a movement of mass is indeed present. By way of this, false alarms for example can be ruled out to an improved extent.

A further advantage is that the determining of the path is reliably possible independently of weather conditions and independently of viewing conditions.

Furthermore, it provides information on the dynamics of the movement of mass event (specifically the speed in dependence of the time), which was not possible given a purely optical determining of the path. By a determining the path being possible in real time, it can also serve to improve the monitoring of the terrain, apart from obtaining insights.

Another advantage is the fact that the determining of the path can be accomplished automatically without a qualified person having to invest time, for example for the analysis of picture data or for computations. At the least if a radar device is present already—for example for avalanche or rockfall warnings —, then the invention consequentially is also economically advantageous.

The determining of a path from a temporal development of radar signals (the so-called radar tracking) is already known for civil and military flight monitoring systems. The path of an aircraft is extracted from the determined radar signals, in order to simplify the tracking for the monitoring person. That principle presupposes the radar signal generating one point per object to be monitored (i.e. the object has an unambiguous coordinate and an unambiguous speed). This presupposition is not given in the case of movements of mass in terrain since the movement of mass has a significant spatial extension, and values such as speed, direction etc. are not identical over the whole spatial extension. It would not make much sense and moreover would be cumbersome—and indeed would also not be readily possible due to difficult assignments—to apply the known tracking principle to all points which are detectable in the radar signal in case of a movement of mass. Instead of this, i.e. instead of an attempt to detect a bundle of very many paths, according to the invention a path which is characteristic of the complete movement of mass is determined. It has been found that this approach makes sense and that it permits a meaningful discrimination by way of a comparison with paths which already have been determined before and/or with a movement equation which takes into account knowledge of the terrain.

In particular, the radar device is stationary, i.e. generally the emitting antenna(e) as well as the receiving antenna(e) are stationary. Here, what is to be understood as a “stationary” radar device is a radar device which can be assembled and operated in a stationary arrangement, thus one which is stationary with respect to the ground and has and/or requires no antennae which move with respect to the ground—this for example is in contrast to radar devices which are assembled on the aircraft or satellites or radar devices which are assembled in a motor vehicle or to radar devices which include a carriage, on which the antennae are moved, wherein such devices, being mobile radar devices, are only capable of functioning when the antennae are moved relative to the terrain to be monitored. The radar device often can do completely without moving parts, wherein, course not, the use of auxiliary means with moving parts (for example a fan, a hard disk or the like) is not ruled out. The set of radar antennae as a whole being rotatable for example about a vertical axis, if for example the monitored terrain is not always the same, is likewise not ruled out. For example, it can indeed be the case that it is not the same region which needs to be monitored in summer and winter. Likewise conceivable is that a different region is to be monitored at night than during the day.

In particular, the radar device can be a FMCW (frequency modulated continuous-wave) radar device. This means that the radar device can be configured to emit the emitting signal with a modulated emitting frequency, in particular as a sequence of frequency ramps (“chirps”).

In particular, the radar device includes a plurality of receiving antennae and/or a plurality of emitting antennae. In particular, these are assembled and/or can be assembled in a manner distributed in the horizontal direction. Apart from a resolution in “range” which generally results in a direct manner (from a frequency shift between the emitting and receiving signal in case of an FMCW radar), the signal can therefore also be resolved in the azimuth. Since a high resolution of the position is not needed for determining the path, in practise it can already be sufficient that two receiving antennae are present which are arranged next to one another (relatively closely for a large region of unambiguity), in addition to a single emitting antennae.

For example, the presence of a movement of mass activity at a certain position can in the simplest case be concluded directly from the radar signal. For example, one can examine whether the radar signal significantly deviates from a background value—for example from an average value. If this is the case, one concludes that a movement can be deduced at this position.

Alternatively or in addition, it is possible that to each position coordinate, a certain movement value (in particular a speed value, for example a speed or a Doppler shift) is assigned which is determined quantitatively, for example by way of Fourier transformation, and this speed value is evaluated—for example, depending on the terrain, the presence of a movement of mass can be deduced if a significant movement in the direction of the radar device is ascertained.

When a possibly relevant movement is to be extracted from a radar signal, a cloud of points with a (possible) movement of mass activity results by way of a suitable differentiation method (for eliminating the background, fluctuations etc.), wherein each point includes a position coordinate. Optionally, a quantitative movement value (Doppler shift, speed) can be assigned to each point.

The differentiation method for example can include that a long-term average is determined per position coordinate (for example per range bin, i.e. per range value region, or as well per range azimuth bin). This is effected for example by way of applying a low-pass filter with a large time-constant of for example at least one minute or two minutes, or five minutes or more, for example 10-15 minutes, to the radar signal. This long-term average is subtracted from the current signal, for example is divided by a likewise continuously determined variance, and the obtained value is compared to a threshold value. If the value lies above the threshold value, the respective position (the respective point) is taken into account. If a movement of mass event is present, the mentioned cloud of points consequently results at the place where the movement of mass event occurs.

In a group of embodiments, it can in particular be provided that the evaluation of the long-term average is interrupted when and where the discrimination which is yet described hereinafter indeed ascertains a movement of mass event. This means that the background at the location of the movement of mass event is quasi frozen: for the differentiation method, that long-term average is used which had been determined before the movement of mass event. This way, the fact is taken into consideration that certain movement of mass events, for example snow avalanches, can need longer than a few seconds to move past a certain location. Without stopping the evaluation at such a location, the movement of mass event could therefore distort the determining of the long-term average and in the end distort the differentiation.

Subsequently to the differentiation method, the resulting points can be grouped, in particular by way of a clustering method. In a group of embodiments, this is effected without making an assumption about the number of clusters.

For the clustering method, for example, the means and algorithms which are known per se for cluster analysis and group assignment can be used, wherein the vectors to be grouped can include the position coordinates, and wherein for example the active clusters which are determined in past time intervals can be included, which above all can be of relevance if several simultaneously active paths lie close to one another and/or approach one another.

Supplementarily or alternatively, the determined speed values (for example in the form of the value of the Doppler shift) can optionally also be incorporated into the clustering method, for example in that the vectors to be grouped include these speed values, apart from the positioning coordinates.

The cluster analysis results in a number of clusters (in case of an avalanche fall often a single cluster; but two, three or more clusters can also result). Furthermore, in the cluster analysis, points which cannot be assigned to any cluster can also result. The latter are for example not taken into account in the subsequent determining of the path.

In embodiments in which a clustering method is used, a path and possibly an extension of the movement of mass event is determined per cluster.

For determining the path, a standardised distribution of the points within the cluster can be assumed—for example a Gaussian normal distribution,—in case of several identified clusters, this applies to each cluster, which is why one path results per cluster. This way results, in a direct manner, a spatial centre of the cluster and a path from a temporal development of this spatial centre. Supplementarily or alternatively, it is also possible that a front of the cluster is used for determining the path or at least is taken into account therefor. A front of the movement of mass for a certain cluster results for example by taking into account those points of the cluster which are located at the very front with respect to the slope inclination, for example which are located closest to the radar device.

For determining the path, the temporal development is taken into account, i.e. possibly the centre of the cluster, the front or another geometric feature is tracked as a function of time.

In embodiments, it can be provided that, apart from the actual radar signal, yet further criteria are used in order to deduce the presence or absence of a movement of mass.

For example, in embodiments, the mentioned temporal development is yet subjected to discrimination, taking into account information on the terrain. For example, events can be discarded very quickly if the movement direction which results from the temporal development cannot be brought into agreement with the physical conditions—for example movements of mass for which an uphill direction or a lateral direction is ascertained instead of a downhill direction. This procedure permits an increase in the sensitivity of the measurement, for example by way of applying not too high a threshold value in the differentiation method, since possible artefacts or signals which originate from other movements (for example from passing-through cars) can be ruled out in a very quick and reliable manner by way of the discrimination.

An example for a suitable discrimination method is the use of a linear filter, for example a Kalman filter with the movement equations which apply to a movement of mass in the terrain as a constraint. The parameters of the filter accordingly can contain assumptions about the dynamics of the movement of mass, thus assumptions about the speed as well as about the direction and in embodiments for example also about the size (spatial extension). A simplified model of the terrain can a serve as a basis for this by way of the terrain being approximated by inclined planes, wherein the geometric characteristics of the planes serve as parameters.

In addition to the path, in particular also the extension of the movement of mass can also be determined, i.e. ultimately the complete, approximately determined contour picture, thus the outline. The extension can also result directly from the model parameters of the standardised distribution. For example, in case of the application of the Gaussian normal distribution, it can result from the path as well as from the standard deviation by way of, in the horizontal direction, assuming an interval of plus-minus the standard deviation or of a certain multiple of the standard deviation around the path.

In embodiments, a recognised path can be assigned to a path which has already been recognised at an earlier point in time, inasmuch as such exists. This way, the determining of the path also permits very short-term prognoses on the further course of the movement of mass. The determining of the path can then also be incorporated into the monitoring of the terrain and into the activation of possible measures. For example, it can be provided that a road which leads through the monitored terrain or lies below the monitored terrain is blocked only when the ascertained movement of mass is assigned to a path which also does not rule out a danger to the road, or if it cannot be assigned to a known path. If in contrast it is assigned to a path which entails no danger to the road, then the road can remain open. In this way, the procedure according to the invention can also be used for avoiding false alarms.

If a path is recognised which cannot be assigned to an already stored path, then this path can be newly stored and can serve, together with the already stored paths, as a reference for future events.

A system is described in this text which includes a radar device and moreover an evaluation unit which is configured to carry out certain evaluation steps. The fact that the system or the evaluation unit is “configured” to carry out certain steps means that such steps are not only possible, but that the system and the evaluation unit, respectively, also includes the means for carrying them out—such means can include hardware and/or software. For example, the evaluation unit is programmed to determine the path of the movement of mass and to also output the path via a display or an interface when required—or in a continuous manner.

In addition to a system, also a method for determining a path constitutes subject-matter of the present invention. In particular, the method can include the steps for whose execution the system described in this text is configured.

### BRIEF DESCRIPTION OF THE DRAWINGS

The subject-matter of the invention is explained hereinafter in more detail by way of the accompanying drawings. In the drawings, the same reference numerals denote the same or analogous elements. The drawing are schematic and not true to scale. There are shown:

FIG. 1 A system for determining a path of a movement of mass, positioned relative to a terrain;

FIG. 2 a schematic diagram of elements of a radar device as part of the system;

FIG. 3 an illustration of steps of the evaluation method; and

FIG. 4a-4f a temporal sequence with points, for which the receiving signals can conclude a movement, wherein further steps of the evaluation method are explained by way of the sequence.

### DETAILED DESCRIPTION OF THE INVENTION

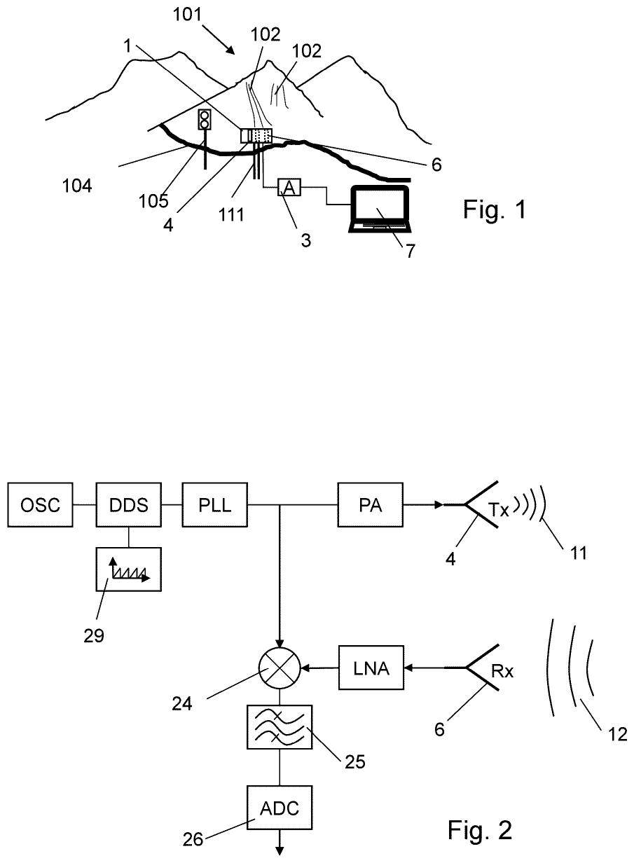

FIG. 1 shows a radar device 1 of the type according to the invention, the radar device being positioned relative to a terrain 101 in which avalanche falls, rockfall events and/or other movements of mass are to be expected. The radar device is stationary and is provided with a suitable mount 111 by way of which it can be set up and anchored in the terrain in a stationary manner. Two avalanche regions 102 in which avalanche falls are a cause for concern are schematically drawn in FIG. 1 in the region covered by the radar device, wherein in case of an avalanche fall in one of the two avalanche regions, a road 104 which passes therebelow could be at risk (analogously, rockfall events or other movements of mass could also be of relevance). Likewise indicated is a signal facility 105, by way of which the road can be blocked if an endangering event is ascertained. A typical distance between the radar device and the monitoring region is between a fraction of a kilometre and several kilometres, for example 0.5-5 km.

The radar device includes an emitting antenna 4 and at least two receiving antennae 6, wherein the two receiving antennae are spaced from one another in the horizontal direction. The distance of the receiving antennae 6 from one another can be a value between roughly half a wavelength and one wavelength, i.e. at 17 GHz between just below 0.9 cm and just below 1.8 cm.

Alternatively to an arrangement with at least two receiving antennae, an arrangement with only one receiving antenna, but with at least two emitting antennae can be present. For the resolution in the azimuth, it is of importance that phase differences can be ascertained in dependence of the azimuth angle (and thus of the horizontal position of the elements which reflect the radar waves).

The radar device is connected to an evaluation unit 3 in which amongst other things a path in the terrain is determined on the basis of the received radar signals. The evaluation unit can be integrated into the antenna or be arranged separately from it; it can also include elements which are integrated into the antenna as well as separate elements. The hardware of the evaluation unit can include dedicated elements, for example at least one FPGA and/or a dedicated graphic processor and/or it can be also be partly formed by a universal computer. The word evaluation “unit” thus does not imply that the elements of this evaluation are physically continuous.

The evaluation unit can also include a communication unit for the connection to a network and/or a separate operating computer 7.

FIG. 2 shows a schematic diagram of elements of the control and evaluation unit together with an emitting antenna 4 and a receiving antenna 6. A clock generator OSC clocks a numerically controlled oscillator (DDS) which with the help of a control signal 29 generates a frequency ramp which in turn serves as a reference for a subsequently arranged phase control loop with a high-frequency oscillator (PLL) and generates a frequency-modulated, phase-stable emitting signal, for example in a frequency band in the gigahertz region.

The frequency-modulated emitting signal has a frequency which is suitable for radio waves for the envisaged application and as the case may be is legally approved. For example, it varies in a frequency band around 17 GHz. The emitting signal is fed to the emitting antenna in a manner amplified by a suitable amount, for example by a power amplifier PA, the emitting antenna emitting the respective primary radio waves 11.

On account of the emitting signal, the emitting antenna 4 generates primary radio waves 11 which are reflected back by the terrain 101, to which possible moving objects also belong, so that the thus arising secondary radio waves 12 can be detected by the receiving antennae 6.

The secondary radio waves 12 which are reflected back by the terrain generate a receiving signal in each of the receiving antennae 6 and this receiving signal after a suitable amplification (LNA) is mixed with the emitting signal (mixer 24). Therein, generally an individual mixer 24 which is situated locally in the direct vicinity of the receiving antennae is assigned to each receiving antenna 6.

In a way know per se, a mixing signal results at the output side of the mixer 24 which includes signal components with the sum of the frequencies of the emitting signal and receiving signal as well as signal components with the differential frequency. The high-frequency shares are filtered out by way of a low-pass filter, so that only signal components with the differential frequency are processed further. This filtered mixed signal (“intermediate frequency signal”) provides information, since, due to the frequency ramps (chirps), the frequency difference between the emitting signal and receiving signal is dependent on the running duration, i.e. on the time duration between the emitting and receiving and on the Doppler shift. This fact underlies the functioning principle of FMCW (frequency modulated continuous-wave) radar devices and is described in the literature.

Additionally to the mentioned low-pass filter, a high-pass filter can also be applied to the mixing signal, in order to filter out very low-frequency signal components which in particular originate from reflections close to the emitting antenna. Such low-frequency signal components are often comparatively energetic and provide hardly any information at all.

The functionalities of the low-pass filter and of the optional high-pass filter are implemented in a band-pass filter 25 in the embodiment of FIG. 2; however it is also possible for the low-pass filter and the high-pass filter to be present as separate elements which are arranged one after the other.

The resulting, possibly high-pass filtered intermediate frequency signal is fed to a subsequent evaluation after analog-to-digital (ADC) conversion. This evaluation includes for example a first Fourier transformation per chirp for determining a range resolution, and under certain circumstances a second Fourier transformation over the chirps for determining a Doppler frequency shift and a phase, as well as a comparison of the respective results per receiving antenna for a resolution in the azimuth

The thus obtained signal 41 which is resolved in range and azimuth, as is illustrated in FIG. 3—is led, per range azimuth bin, to the evaluation 42 of a long-term average, for example with a time constant between 10 and 15 minutes. This long-term average is subtracted from the signal (subtraction 43) for the mentioned differentiation method inasmuch as a movement of mass event has not been assigned to the respective coordinates (see the subsequent steps). If in contrast a movement of mass event has been ascertained, then the long-term average of before the movement of mass event is used instead of the current long-term average (44; dashed line).

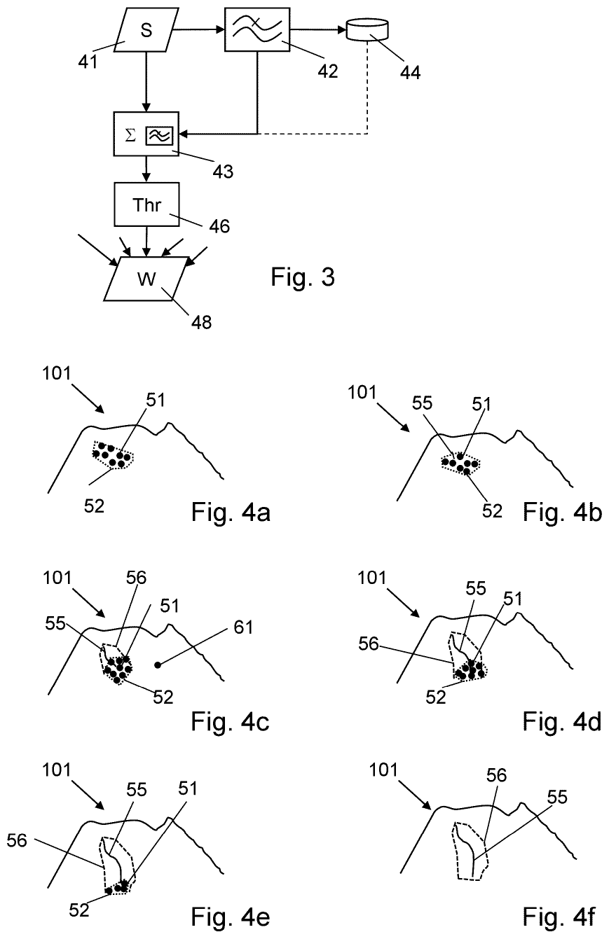

The result—under certain circumstances after the division by the variance or another value which represents the expected fluctuations—is compared to a threshold value (comparison 46). If it is larger than the threshold value, it is taken into account, otherwise not. Given the presence of a movement of mass, a cloud 48 of points 51 arises for all range azimuth bins as a result of this evaluation, each of the points 51 being assigned to a respective position in the terrain 101 by way of the range azimuth coordinates. By way of example, FIGS. 4a-4f show a temporal sequence during a movement of mass event.

The determined points 51 are subjected to a cluster analysis in a next step, wherein no cluster, one cluster 52 or several clusters can result. Apart from the position coordinates, the measured Doppler shifts can be incorporated into the cluster analysis.

A single cluster 52 of points which is represented by a dotted outline is represented in the represented embodiment example. As is indicated in FIG. 4c, singular points 61 which cannot be assigned to a cluster and which for example also disappear again can also be measured. These are discarded and have no influence on determining of the path or the outline.

A standardised distribution, for example a Gaussian normal distribution is assumed for the cluster. A centre of the cluster results from this. A path 55 results from a temporal development of this centre.

Other procedures for determining the cluster centre are also possible, for example by way of the vertical (and under certain circumstances also the horizontal) line which divides the cluster into two equally large parts being sought, determining the arithmetic mean of the positions of the points, etc. The temporal development of the centre can result in the path in such cases too.

As an alternative to the centre of the cluster, one can also use a different characteristic of the cluster for determining the path. For example, a front of the movement of mass can be determined (at the lower side on the point cloud in FIG. 4a-4f) based on the movement direction (see also below), and a centre of this front can define the path. The front can be formed by the points which are at the very front with respect to the inclination of the slope, thus are generally closest to the radar device.

Further different approaches can also yet be found, for example by way of means for image processing.

In embodiments, a discrimination between real movement of mass events and artefacts follows in a further step. This discrimination is effected for example by way of a linear filter, for example a Kalman filter. Herein, whilst taking into account the movement equations, one examines whether the determined path (including the propagation speed; here the “propagation speed” means the speed at which the front or the centre of the movement of mass moves across the terrain; the propagation speed does not need to be identical to the speed which results from the measured Doppler shift) corresponds to a realistic path. The information on the peculiarities of the terrain which is known beforehand and is stored in the evaluation unit 7 is incorporated into the movement equations which for their part can be incorporated into the constraints for the applied filter function. This information can contain for example a simplified model of the terrain, in which model the terrain is, in a section-wise manner, modelled by inclined planes. The parameters of this model are determined beforehand, for example based on cartographic data or based on newly carried out measurements. They are permanently stored in the evaluation unit, explicitly as terrain parameters (e.g., in form of coordinates and inclination of the inclined planes), and/or implicitly as filter parameters.

If in the discrimination, a measurement turns out to be plausible, i.e. to be compatible with a movement of mass, it is then followed up in order to develop the path 55 as is illustrated in the FIGS. 4a-4f Otherwise it is discarded. This procedure of the discrimination can be relatively rapid, i.e. within a few seconds it can turn out whether an effective movement of mass is present or not.

As already mentioned above, the information as to whether a movement of mass has been made plausible or not can also be incorporated into the determining of the long-term average for the purpose of background subtraction. The long-term average for example is frozen to the last determined value before the onset of the movement of mass.

In addition to the path, also an outline 56 can be determined parallel to thereto, the outline recording the spatial extension of the movement of mass. On assuming a standardised distribution, a lateral extension—and thus, when taking into account the course, the complete outline—can be readily determined from the assumption of a certain width resulting from the standardised distribution, thus for example from the path and, given a Gaussian normal distribution, from the parameter a (“standard deviation”) which determines the width transverse to the path.

A determined path 55 and/or possibly a determined outline 56 can be compared to already stored paths/outlines of past events. If an agreement is found, then this information can be incorporated for example into the functioning manner of a warning function. For example, in FIG. 1, avalanches in an avalanche region (represented at the left in FIG. 1) create a risk to the road 104, wherein avalanche paths in another avalanche region (at the right in FIG. 1) leads to no risk due to the topography.

If a determined path does not correspond to an already stored path, then it can be newly stored and can be incorporated into prognoses in the context of future movement of mass events.

Under certain circumstances, it can also be provided that an already stored path is deleted from the data bank after a certain period of time if it corresponds to no path effectively measured in this period of time.

1. A system for determining a path of a movement of mass in a terrain, comprising a radar device with at least one emitting antenna for emitting primary radio waves and at least one receiving antenna for generating receiving signals which are caused by secondary radio waves which are reflected back by the terrain due to the primary radio waves, as well as an evaluation unit which is configured to conclude the presence or absence of a movement of mass activity from the receiving signals in dependence of at least one position coordinate, from which movement of mass activities result for different positions which are represented by position coordinate values, wherein the evaluation unit is further configured to determine the patch of the movement of mass from a temporal development of the positions, for which a movement of mass activity has been ascertained.

2. A system according to claim 1, wherein the evaluation unit is configured to determine, per position, a long-term average of the receiving signal, and wherein ascertaining of the movement of mass activity includes a comparison between the receiving signal and the long-term average.

3. The system according to claim 2, wherein the comparison comprises examining as to whether a difference between the receiving signal and the long-term average fulfills a threshold value condition or not.

4. The system according to claim 2, wherein measurements of the receiving signal which take place during an ascertained movement of mass activity are not taken into account in determining the long-term average.

5. The system according to claim 1, wherein the evaluation unit is configured to subject those positions for which the receiving signals conclude a movement, to a clustering method and to determine the path per cluster.

6. The system according to claim 5, wherein vectors to be grouped for the clustering method comprise the position coordinate of the positions for which a movement of mass activity has been ascertained.

7. The system according to claim 5, wherein the evaluation unit is configured to assume a standardised distribution, for example a Gaussian normal distribution, for the cluster which results with the clustering method.

8. The system according to claim 1, wherein the evaluation unit is configured to carry out a discrimination step for determining the path, in which discrimination step the temporal development of the positions is compared to at least one movement equation.

9. The system according to claim 8, wherein a Kalman filter is used for the discrimination step.

10. The system according to claim 8, wherein the discrimination step is carried out in real time and executed during a suspected movement of mass event, so that a discrimination can be completed before the suspected movement of mass event is finished.

11. The system according to claim 1, wherein the evaluation unit is configured, apart from the path, to also determine an outline of the movement of mass.

12. The system according to claim 1, wherein the evaluation unit comprises a data bank with stored possible paths, and wherein the evaluation unit is configured to compare the path of the movement of mass with the possible paths.

13. The system according to claim 12 which is configured to store the path of the movement of mass in the data bank with stored possible paths when it cannot be assigned to any stored possible path.

14. The system according to claim 1, which comprises a plurality of receiving antennae and/or a plurality of emitting antennae, which is why the position coordinate values are dependent on range and azimuth.

15. The system according to claim 1, wherein the at least one emitting antenna and the at least one receiving antenna are stationary.

16. A method for determining a path of a movement of mass in a terrain, wherein primary radio waves are emitted, and wherein secondary radio waves which are reflected by the terrain due to the primary radio waves cause a receiving signal, wherein the receiving signal is evaluated in dependence of at least one position coordinate, in order to deduce a presence or absence of a movement of mass activity, from which movement of mass activities for different positions which represent position coordinate values result, and wherein a path of the mass movement is determined from a temporal development of the positions for which a movement of mass activity has been ascertained.
